(19) United States
(12) Patent Application Publication
(10) Pub. No.: US 2024/0151892 A1
(43) Pub. Date: May 9, 2024

(54) ILLUMINABLE GLAZING

(71) Applicant: SAINT-GOBAIN GLASS FRANCE, COURBEVOIE (FR)

(72) Inventors: Semjon MOORAJ, AACHEN (DE); Tobias NIELSEN, KÖLN (DE)

(21) Appl. No.: 18/550,056

(22) PCT Filed: Apr. 4, 2022
(86) PCT No.: PCT/EP2022/058894

§ 371 Date: Sep. 11, 2023

(30) Foreign Application Priority Data
Apr. 15, 2021 (EP) 21168569.8

(51) Int. Cl. F21V 8/00; B32B 17/10; B60Q 3/208

(52) U.S. Cl. CPC G02B 6/0043; B32B 17/10036; B32B 17/10541; B32B 17/10651; B32B 17/10761; B32B 17/10807; G02B 6/0051; G02B 6/0095; B60Q 3/208

(57) ABSTRACT

A glazing arrangement includes a first pane having a first main surface and a second main surface, wherein the first pane is provided to at least partially transmit coupled light, a light source for producing light that can be coupled into the first pane, a light extraction system to couple light out of the first pane via one of the two main surfaces, wherein the light extraction system includes a transparent coating with a refractive index that differs from, in particular is higher than, that of the air and that of the first pane, which transparent coating is arranged in a planar manner at least sectionally on one of the two main surfaces.

The invention relates to a glazing arrangement with a light source and a light extraction means, a method for production thereof, and use thereof.

Composite panes as glazings consisting of two or more glass or polymeric panes are used in vehicles as windshields, rear windows, side windows, and roof panels. In the case of illuminable or illuminated glazings, light from a light source is coupled into a flat light guide in the form of a pane of the glazing utilizing total reflection.

WO 2010/049638 A1, WO 2013/053629 A1, WO 2014060409 A1, or WO 2015/095288 A2 disclose the coupling of light into a glass pane via a side face. From WO2013/110885 A1, WO2018178591 A1, or WO2019/105855 A1, it is known to arrange the light source in a recess and to thus couple the light into the pane.

To date, panes with an illuminated switching surface that include a light deflection means for marking an area are known. The light coupled in a pane strikes the light deflection means and is deflected such that it leaves the pane. The light deflection means usually consists of structures that include particles, dot grids, stickers, or imprints. Here, it is disadvantageous that these structures are very clearly visible even when the light source is switched off.

WO2020/188078 A1 discloses a laminated glazing having a light source. The light emitted by the light source is guided through the laminated glazing via a glass substrate or a polymeric intermediate layer. The laminated glazing further has a light input surface for introducing the light emitted by the light source as well as a light extraction surface for extracting the light.

US2018/074251 A1 discloses a glazing unit with a light source and a light extraction system containing scattering dielectric particles.

The object of the present invention consists in providing an improved glazing arrangement in which light extraction means are hardly visible even when the light source is switched off.

The object of the present invention is accomplished according to the invention by a glazing arrangement in accordance with claim 1. Preferred embodiments are apparent from the subclaims.

The glazing arrangement according to the invention comprises at least a first pane, a light source for producing light that can be coupled into the first pane and a light extraction means for coupling light out of the first pane, wherein the pane is provided to at least partially transmit coupled light. The first pane has at least a first main surface and a second main surface The light extraction means are provided for extracting the light via one of the two main surfaces.

For this purpose, the light extraction means has a transparent coating with a refractive index different from that of the air and that of the first pane. The transparent coating is applied in a planar manner at least sectionally on one of the two main surfaces. The coating can preferably comprise titanium oxide (TiOx).

In an advantageous embodiment, the refractive index of the transparent coating n_{B} is preferably approx. 2.5. Because of the fact that the refractive index of the transparent coating n_{B} differs greatly from the refractive index n_{L} of the surrounding air and from the refractive index of the first pane ns, the light is refracted and coupled out at the transition from the pane to the coating and at the transition from the coating to the air. Advantageously, the coating is transparent and thus virtually invisible to the human eye even when the at least one light source is switched off. Furthermore, the coating can have a layer thickness of 300 nm to 200 μm, preferably 300 nm to 400 nm.

A coating, in particular a pane or an object, is understood to be “transparent”, when the coating, the pane, or the object has transmittance in the visible spectral range of more than 20%, preferably 50%, particularly preferably of more than 70%, in particular of more than 85%.

In another advantageous embodiment, the coating is roughened. In other words, the coating acquires roughness through patterning. For this purpose, after being applied to one of the two main surfaces, the coating is at least partially removed. Clean removal of the coating does not occur, instead, residues of the coating remain on one of the two main surfaces. The at least partial removal of the coating can be done by laser. As a result of the laser treatment, the coating has an irregular rough pattern and thus has a light-scattering effect. For example, the coating can have patterning in the form of circular areas. The circular areas can have a diameter of 10 μm, 200 μm, or up to 1 mm.

For effective light extraction, it is an advantageous embodiment for the coating to include multiple, in particular spherical, body elements. In other words, the body elements are embedded in the coating. The body elements are preferably transparent. As a result of the fact that the light propagating in the first pane is scattered on the body elements, particularly effective light extraction is achieved.

In another advantageous embodiment of the invention, the body elements, which are, in particular spherical, are elliptical, cylindrical, or spheres. Due to a suitable shape of the body element, for example, a spherical shape, the light can be extracted from the light guide by utilizing refraction, reflection, and scattering. In order to enhance the scattering of the light, the spherical body elements can be partially filled or hollow, in particular, filled with air.

In another embodiment of the invention, the body elements can additionally be coated with a coating of titanium oxide or a fluorescent substance such that the scattering of the light is further enhanced.

For example, the body elements can, as spheres, have a diameter of 1 μm to 200 μm, preferably 5 μm to 100 μm, particularly preferably 50 μm to 80 μm. In the case of a cylindrical body element, the cylindrical body would have a length of 1 μm to 200 μm, preferably 5 μm to 100 μm, particularly preferably 50 μm to 80 μm. The, in particular spherical, bodies can have different sizes. Preferably, the body elements can be made of glass and/or polymer material. The glass and/or the polymer material are preferably transparent. For example, the body elements can be arranged in a single layer of the coating.

In another preferred embodiment, the coating is arranged or applied directly on the first main surface (IV) and/or on the second main surface (Ill). This is, in particular, the viewing area of the first pane. The coating can cover an area of at least 1 mm², preferably 1000 mm² to 1 m².

The light source of the glazing arrangement according to the invention comprises at least one or more light-emitting diodes (LED). Additionally, or alternatively, the light source can comprise an organic light-emitting diode (OLED) or a laser, with the light source preferably arranged on an end face of the first pane. Alternatively, or additionally, the light source can emit infrared or ultraviolet light, which is preferably converted into visible light by florescent or luminescent particles, preferably as a component of the light extraction means.

In an embodiment of the invention, the glazing arrangement can additionally include a light coupling means that is connected to the first main surface. In this case, the light source is arranged adjacent the light coupling means such that the light of the light source can be at least partially coupled into the first pane via the light coupling means. The light coupling means is intended to deflect part of the light incident from the light source in transmittance by scattering, reflection, refraction, or diffraction.

In another preferred embodiment, the glazing arrangement according to the invention has a composite pane. The composite pane comprises the first pane, which is joined to a second pane via an intermediate layer to form the composite pane. Preferably, the two panes and the intermediate layer therebetween are joined in a planar manner by lamination.

In principle, all electrically insulating substrates that are thermally and chemically stable as well as dimensionally stable under the conditions of production and use of the composite pane are suitable as the first pane and the second pane.

The first pane and/or, if present, the second pane preferably contain glass, particularly preferably float glass made of clear glass, most particularly preferably diamond glass. Alternatively, the panes can also contain flat glass, such as soda lime glass, borosilicate glass, or quartz glass, or clear plastics, rigid clear plastics, in particular polyethylene, polypropylene, polycarbonate, polymethyl methacrylate, polystyrene, polyamide, polyester, polyvinyl chloride, and/or mixtures thereof. The first pane and/or the second pane are preferably transparent, in particular for the use of the panes as a windshield or a rear window of a vehicle or other uses in which high light transmittance is desired. In particular, at least the first pane and preferably also the second pane are made of clear glass.

However, for panes that are not located in the driver's traffic-relevant field of vision, for example, for roof panels, the transmittance can also be much lower, for example, greater than 5%. For this purpose, the second pane and/or the intermediate layer can be tinted or colored, for example.

The thickness of the first pane and/or the second pane can vary widely and thus be ideally adapted to the requirements of the individual case. Preferably, standard thicknesses of 1.0 mm to 25 mm, preferably of 1.4 mm to 2.5 mm are used for vehicle glass; and preferably of 4 mm to 25 mm, for furniture, appliances, and buildings. The size of the panes can vary widely and is governed by the size of the use according to the invention. In the automotive and architectural sector, the first pane and the second pane have, for example, customary areas of 200 cm² up to 20 m².

The glazing can have any three-dimensional shape. Preferably, the three-dimensional shape has no shadow zones such that it can, for example, be coated with additional coatings by cathode sputtering. Preferably, the panes are planar or slightly or highly curved in one or more spatial directions. In particular, planar substrates are used. The panes can be colorless or colored.

In the case of a composite pane, the first pane and the second pane are joined to one another by at least the intermediate layer. The intermediate layer is preferably transparent or tinted or colored. The intermediate layer preferably contains at least one plastic, preferably polyvinyl butyral (PVB), ethylene vinyl acetate (EVA), and/or polyethylene terephthalate (PET). However, the intermediate layer can also contain, for example, polyurethane (PU), polypropylene (PP), polyacrylate, polyethylene (PE), polycarbonate (PC), polymethyl methacrylate, polyvinyl chloride, polyacetate resin, casting resins, acrylates, fluorinated ethylene propylenes, polyvinyl fluoride, and/or ethylene tetrafluoroethylene, or copolymers or mixtures thereof. The intermediate layer can be formed by one or even by a plurality of superimposed films, the thickness of a film preferably being from 0.025 mm to 1 mm, typically 0.38 mm or 0.76 mm. The intermediate layers can preferably be thermoplastic and, after lamination, bond the first pane, the second pane, and any other intermediate layers to one another. Particularly advantageous are so-called “acoustic-damping” intermediate layers, which preferably consist of three plies of PVB, with the middle ply softer than the two outer plies.

The intermediate layer can also have a functional layer, in particular an infrared-radiation-reflecting layer, an infrared-radiation-absorbing layer, a UV-radiation-absorbing layer, an at least sectionally colored layer, and/or an at least sectionally tinted layer. The thermoplastic intermediate layer can, for example, also be a band filter.

The terms “first pane” and “second pane” are chosen to distinguish the two panes in a composite pane according to the invention. No statement regarding the geometric arrangement is associated with the terms. For example, if the composite pane according to the invention is intended, in an opening, for example, of a vehicle or a building to separate the interior from the external surroundings, the first pane can face the interior or the external surroundings.

Furthermore, the first pane and/or the second pane can have further suitable coatings, for example, an anti-reflection coating, a nonstick coating, an anti-scratch coating, a photocatalytic coating, a sun-shading coating, and/or a low-E coating.

The glazing arrangement can further include other optional functional elements, in particular electronically controllable optical elements, for example, PDLC elements, electrochromic elements, or the like, which are typically arranged between the first pane and the second pane.

The first pane and the second pane are laminated to one another via the intermediate layer, for example, by autoclave methods, vacuum bag methods, vacuum ring methods, calender methods, vacuum laminators, or combinations thereof. The pane is usually bonded under the action of heat, vacuum, and/or pressure.

In a further aspect, the present invention includes a method for producing the glazing arrangement according to the invention, at least comprising:
Arranging at least one light source on a first pane,
Applying a planar coating as a light extraction means at least partially on a first main surface and/or on a second main surface of the first pane, wherein the light extraction means comprises a coating, which is arranged in a planar manner at least sectionally on one of the two main surfaces (Ill, IV).

In a preferred embodiment of the method, the coating can be applied to the first pane by screen printing.

Furthermore, in another advantageous embodiment, the coating is roughened, i.e., the coating acquires patterning. For this purpose, after being applied to one of the two main surfaces, the coating is then at least partially removed. Clean removal of the coating does not occur, instead, residues of the coating remain on one of the two main surfaces. The at least partial removal of the coating can be done by laser. As a result of the laser treatment, the coating has an irregular rough pattern and thus has a light-scattering effect.

The present invention further includes the use of the glazing arrangement according to the invention in means of locomotion for travel on land, in the air, or on water, in particular in motor vehicles, for example, as a roof panel.

Within the scope of the present invention, all embodiments mentioned for individual features can also be freely combined with one another, provided they are not contradictory.

In the following, the invention is explained in greater detail with reference to figures and exemplary embodiments. The figures are a schematic representation and are not to scale. The figures in no way restrict the invention.

They depict:

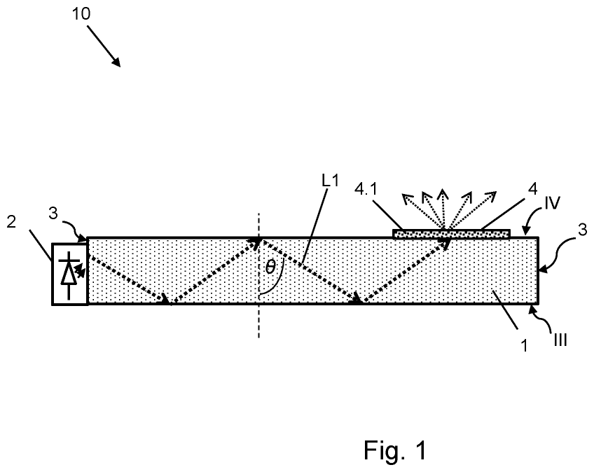

FIG. 1 a schematic cross-sectional representation of an embodiment of a glazing arrangement according to the invention with a single pane,

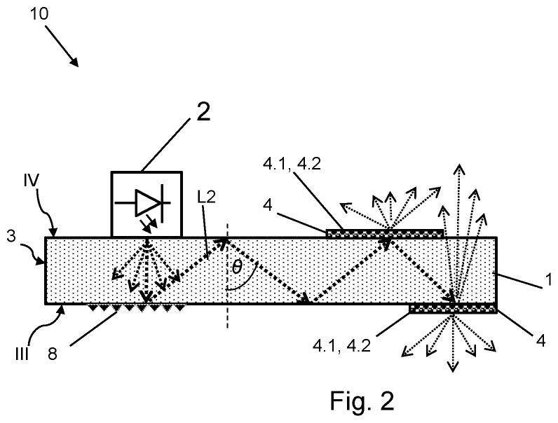

FIG. 2 a schematic cross-sectional representation of another embodiment of a glazing arrangement according to the invention with a single pane,

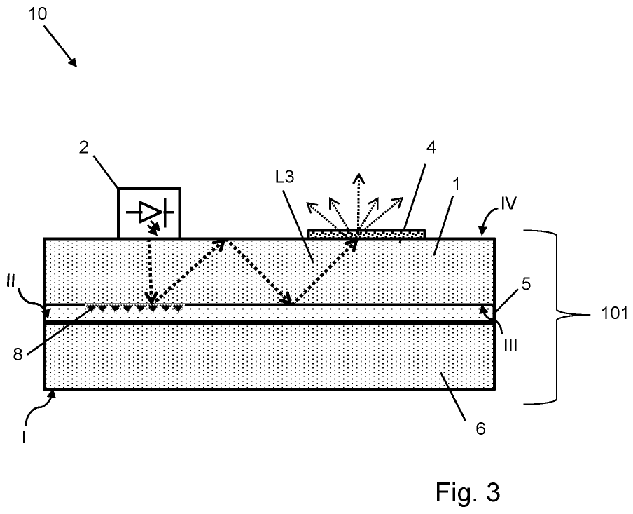

FIG. 3 a schematic cross-sectional representation of another embodiment of a glazing arrangement according to the invention with a composite pane,

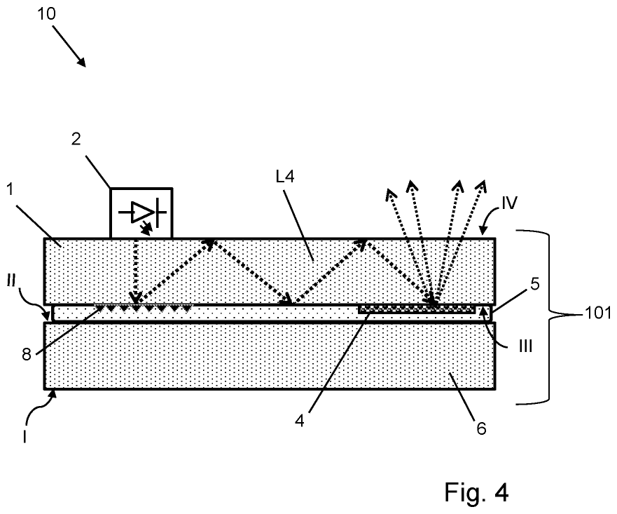

FIG. 4 a schematic cross-sectional representation of another embodiment of a glazing arrangement according to the invention with a composite pane, and

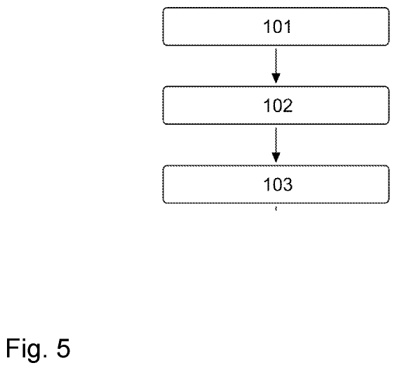

FIG. 5 a flow chart of an embodiment of a method according to the invention, and

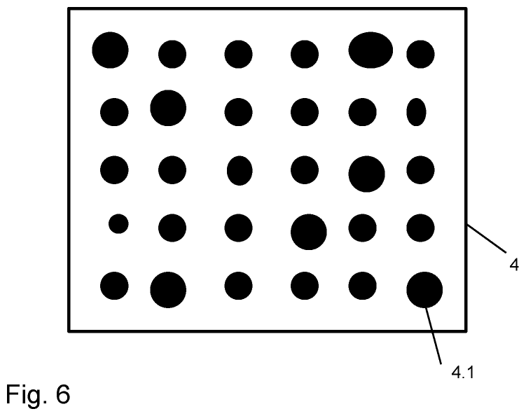

FIG. 6 a schematic plan view of an embodiment of a patterned coating according to the invention as a light extraction means.

Data with numerical values are generally not to be understood as exact values, but also include a tolerance of +/−1% up to +/−10%.

FIG. 1 depicts a cross-sectional representation of a glazing arrangement 10 according to the invention. The glazing arrangement 10 comprises a first pane 1 as a single pane and a light source 2. The single pane can, for example, be an automobile glazing, an architectural glazing, or components of a piece of furniture or an electrical appliance. For example, the glazing arrangement 10 is a roof panel of a vehicle. The glazing arrangement 10 can also be part of an insulating glazing unit and serve, for example, as an outer or inner pane in a window of a building. Furthermore, the glazing arrangement 10 can be installed in an interior space and can, for example, serve as glazing for a conference room.

The first pane 1 has a first main surface IV and another second main surface III opposite the first main surface IV. The first pane 1 is delimited by four circumferential end faces 3, also referred to as side faces. The end faces are arranged orthogonal to the main surfaces III, IV. The first pane 1 is made, for example, of soda lime glass and its dimensions are 1.4 m×1.5 m. The first pane 1 has a thickness of 3 mm. The thickness of the first pane can be adapted to the respective use. The first pane 1 can comprise toughened, partially toughened, or non-toughened glass. Alternatively, the first pane 1 can be made of a plastic, for example, polycarbonate.

In the glazing arrangement 10, the light source 2 is arranged such that light is coupled into the pane 1 on one of the four end faces 3 of the pane 1. The light source 2 is intended to emit light in the visible range. Alternatively, it can emit infrared or ultraviolet light.

The light emitted by the light source 2 is directed toward the pane 1 and strikes, for example, a first end face 3 of the first pane 1. The pane 1 is intended to transmit the light coupled in at the first end face 3 through the pane 1 in the longitudinal direction. In FIG. 1, by way of example, a light beam L1 propagates through the pane 1. Due to the principle of total reflection, the light coupled into the first pane 1 at an angle θ≥θₜₒₜₐₗ propagates through the first pane 1.

The light source 2 of the glazing arrangement 10 can comprise one or more light-emitting diodes (LED). The light source can also comprise an organic light-emitting diode (OLED).

A light extraction means 4 is arranged on the first main surface IV of the first pane 1. At the point where the light extraction means 4 is arranged, the total reflection of the light beam L1 is prevented and the light can emerge from the first pane 1 via the main surface IV. Without the light extraction means 4, the coupled light strikes the surface of the pane 1 at an angle such that total reflection of the light beam occurs.

The light extraction means 4 can be arranged at any point of the main surface IV or the main surface III. In FIG. 1, the light extraction means 4 comprises a transparent coating 4.1. The coating 4.1 has, for example, titanium oxide (TiOx/TiO2). The coating 4.1 is transparent. The layer thickness is 10 μm. The coating 4.1 has a refractive index different from, in particular higher than, that of the air and that of the first pane. The coating 4.1 interrupts the total reflection of the light at the interface between the first pane 1 and the surrounding air, and the light is coupled out of the first pane 1 by scattering. To ensure effective scattering, the coating 4.1 can be roughened by patterning, as shown in FIG. 6.

FIG. 2 depicts a further development according to the invention of the glazing arrangement 10 of FIG. 1. The glazing arrangement 10 of FIG. 2 has a structure similar to the glazing arrangement 10 of FIG. 1. In contrast to FIG. 1, the light source 2 in FIG. 2 is arranged on the main surface IV and not on the end face 3. For this purpose, the glazing arrangement 10 has a light coupling means 8 that is arranged opposite the light source 2 relative to the first pane 1. The role of the light coupling means 8 is to deflect a large part of the light that penetrates into the first pane 1 at an angle θ<θₜₒₜₐₗ and immediately exits again due to a lack of total reflection at the interface opposite the entry surface (here, main surface III) back into the first pane 1, preferably at an angle θ≥θₜₒₜₐₗ. In this case, the light coupling means 8 preferably utilizes mechanisms of reflection, light refraction, diffraction, and/or scattering.

In the exemplary embodiment of FIG. 2, the light coupling means 8 comprises, for example, a microprism film, a patterned plastic film, or a plastic plate with a planar arrangement of microprisms.

In FIG. 2, by way of example, a light beam L2 propagates through the pane 1. The glazing arrangement 10 further includes a first light extraction means 4 on the second main surface III and a second light extraction means 4 on the first main surface IV. Alternatively, the glazing arrangement 10 can include only one of the light extraction means 4.

In order to enhance the scattering of the light emerging from the pane 1, the coating 4.1 can have multiple body elements 4.2. The body elements 4.2 can be spherical. The shape of the body elements 4.2 can be elliptical, cylindrical, or in the form of spheres. When the light source 2 is in operation, the light propagating in the first pane 1 is scattered on the body elements.

By means of body elements 4.2 in the form of spheres, for example, the light can be extracted particularly effectively out of the first pane by utilizing refraction, reflection, and scattering. In order to enhance the scattering of the light, the body elements 4.2 can be partially filled or hollow. Alternatively, or additionally, the body elements 4.2 can be coated with a coating of titanium oxide or a fluorescent substance such that the scattering of the light is further enhanced. Advantageously, the body elements 4.2 are transparent and thus virtually invisible to the human eye even when the light source 2 is switched off.

The body elements 4.2, as spheres, can have a diameter of 1 μm to 200 μm, preferably 5 μm to 100 μm, particularly preferably 50 μm to 80 μm. In the case of a cylindrical body element 4.2, the cylindrical body would have a length of 1 μm to 200 μm, preferably 5 μm to 100 μm, particularly preferably 50 μm to 80 μm. The body elements can have different sizes. Preferably, the body elements 4.2 are made of glass and/or polymer material. The glass and/or the polymer material are preferably transparent. For example, the body elements 4.2 can be arranged in a single layer of the coating.

FIG. 3 depicts a cross-sectional representation of another embodiment of a glazing arrangement 10 according to the invention with a composite pane 101. The composite pane 101 comprises the first pane 1, which is joined to a second pane 6 via an intermediate layer 5.

The first pane 1, the intermediate layer 5, and the second pane 6 were joined to one another by lamination, in particular autoclaving. The second pane 6 has a first main surface II and a further second main surface I opposite the first main surface II.

The first pane 1 of FIG. 3 has a structure similar to the first pane 1 of FIG. 2. In contrast to FIG. 1, the first pane 1 has only one light extraction means 4 on the first main surface IV. The thickness of the first pane 1 is, for example, 1.6 mm, and the thickness of the second pane 6 can be 2.1 m. The first pane 1 and the second pane 6 can have any thicknesses, for example, the same thickness.

The intermediate layer 5 is a thermoplastic intermediate layer. It contains at least one thermoplastic film and, in an advantageous embodiment, is formed by a single thermoplastic film. This is advantageous in terms of a simple structure and low overall thickness of the composite glass. The thermoplastic intermediate layer or the thermoplastic film preferably contains at least polyvinyl butyral (PVB), ethylene vinyl acetate (EVA), polyurethane (PU), mixtures or copolymers or derivatives thereof that have proved useful for composite glasses.

The thickness of the thermoplastic intermediate layer 5 is preferably from 0.2 mm to 1.00 mm. For example, thermoplastic films of the standard thickness of 0.76 mm can be used. The intermediate layer 5 can also be implemented as an acoustically damping 3-ply PVB film.

The first pane 1, the second pane 6, and the intermediate layer 5 are, for example, clear (neither tinted nor colored). Alternatively, the intermediate layer 5 can have a tinted or colored PVB film. Alternatively, or additionally, the second pane 6 can be darkly tinted.

The light extraction means 4 in FIG. 3 is implemented in the form of the roughened coating 4.1. The coating 4.1 has titanium oxide. The coating 4.1 can additionally contain spherical body elements 4.2 in the form of spheres, in particular glass spheres. In FIG. 3, by way of example, a light beam L3 propagates through the pane 1.

The first pane 1 is, for example, intended to face an interior of a vehicle in the installed position. The first main surface IV of the first pane 1 is accessible from the interior, whereas the second main surface I of the second pane 6 faces outward relative to the vehicle interior.

The glazing arrangement 10 depicted in FIG. 3 is particularly suitable as a roof panel of a motor vehicle.

FIG. 4 depicts a cross-sectional representation of another embodiment of a glazing arrangement 10 according to the invention with the composite pane 101. The glazing arrangement 10 of FIG. 4 has a structure similar to the glazing arrangement 10 of FIG. 3. In contrast to FIG. 3, the first pane 1 of FIG. 4 has the light extraction means 4 on the second main surface III of the first pane 1. The light extraction means 4 in FIG. 4 is implemented in the form of the roughened coating 4.1. The coating 4.1 has titanium oxide. The coating 4.1 also has spherical body elements 4.2 in the form of spheres, in particular glass spheres. In FIG. 4, by way of example, a light beam L4 propagates through the pane 1.

The glazing arrangement 10 has the light coupling means 8, which is arranged opposite the light source 2 with respect to the first pane 1. The light coupling means 8 is a microprism film, a patterned plastic film, or plastic plate with a planar arrangement of microprisms. In this case, the light coupling means 8 preferably utilizes mechanisms of reflection, light refraction, diffraction, and/or scattering.

FIG. 5 depicts a flow chart of an exemplary embodiment of the method according to the invention for producing the glazing arrangement 10. The method comprises the following steps:
101 Arranging the light source 2 on the first pane 1,
102 Arranging the light extraction means 4 on a first main surface IV and/or on a second main surface III of the first pane, wherein the light extraction means 4 comprises a coating 4.1, which is arranged in a planar manner at least sectionally on one of the two main surfaces (Ill, IV).

In a preferred embodiment of the method, the coating can be applied to the first pane by screen printing.

The step of arranging the light extraction means 4 can comprise depositing the coating 4.1 on the first pane and, additionally, a step 103 of the partial decoating of the coating 4.1 such that the coating 4.1 is roughened. The coating 4.1 can be roughened by laser. In other words, the coating 4.1 is patterned. The patterning of the coating can comprise multiple circular areas of the coating 4.1. The circular areas can have a diameter from 10 μm to 200 μm, for example, 56 μm, 63 μm, 98 μm, or 112 μm. Improved transparency in the switched off state is achieved without affecting the luminosity in the switched on state.

The coating 4.1 can have multiple body elements 4.2 in the form of spheres. However, the shape of the body elements 4.2 can also be elliptical or cylindrical. The body elements 4.2 can be partially filled or hollow and filled with air. Alternatively, or additionally, the body elements 4.2 can be coated with a coating of titanium oxide or a fluorescent substance such that the scattering of the light is further enhanced. Preferably, the body elements 4.2 are made of glass and/or polymer material. The glass and/or the polymer material are preferably transparent. For example, the body elements 4.2 can be arranged in a single layer of the coating.

FIG. 6 depicts a schematic plan view of an embodiment of the roughened, patterned coating 4.1 as a light extraction means 4. The patterning of the coating 4.1 has multiple circular areas. The circular areas of the coating 4.1 have a diameter of, for example, 56 μm, 63 μm, 98 μm, 112 μm, or 1 mm.

### LIST OF REFERENCE CHARACTERS

1 first pane
2 light source
3 end face
4 light extraction means
4.1 coating
4.2 body element
5 intermediate layer
6 second pane
8 light coupling means
10 glazing arrangement
101 composite pane
L1, L2, L3, L4 light beam
θ angle (theta)
θₜₒₜₐₗ total reflection angle (theta)
I second main surface of the second pane 6
II first main surface of the second pane 6
III second main surface of the first pane 1
IV first main surface of the first pane 1

1. A glazing arrangement comprising:
a first pane having a first main surface and a second main surface, wherein the first pane is provided to at least partially transmit coupled light,
a light source for producing light that can be coupled into the first pane,
a light extraction system adapted to couple light out of the first pane via one of the first and second main surfaces,
wherein the light extraction system comprises a transparent coating with a refractive index that differs from that of the air and that of the first pane, which transparent coating is arranged in a planar manner at least sectionally on one of the first and second main surfaces.

2. The glazing arrangement according to claim 1, wherein the transparent coating is roughened.

3. The glazing arrangement according to claim 1, wherein the transparent coating comprises multiple body elements.

4. The glazing arrangement according to claim 3, wherein the body elements are elliptical, cylindrical, or spheres.

5. The glazing arrangement according to claim 3, wherein the body elements are partially filled or hollow.

6. The glazing arrangement according to claim 3, wherein the body elements are coated with a coating of titanium oxide or a fluorescent substance.

7. The glazing arrangement according to claim 3, wherein the body elements are spheres that have a diameter of 1 μm to 200 μm.

8. The glazing arrangement according to claim 3, wherein the body elements have different sizes.

9. The glazing arrangement according to claim 3, wherein the body elements are made of glass and/or polymer material.

10. The glazing arrangement according to claim 1, wherein the transparent coating has patterning in the form of circular areas.

11. The glazing arrangement according to claim 1, wherein the transparent coating is arranged directly on the first main surface and/or on the second main surface.

12. The glazing arrangement according to claim 1, wherein the transparent coating is arranged on the first main surface, which has an interface with air.

13. The glazing arrangement according to claim 1, wherein the light source includes at least one or more light-emitting diodes.

14. The glazing arrangement according to claim 1, wherein the first pane is joined to a second pane via an intermediate layer to form a composite pane.

15. The glazing arrangement according to claim 1, wherein the transparent coating comprises titanium oxide.

16. A method for producing a glazing arrangement according to claim 1, comprising:
arranging at least one light source on a first pane,
arranging a light extraction system on a first main surface and/or on a second main surface of the first pane,
wherein the light extraction system comprises a coating, which is arranged in a planar manner at least sectionally on one of the two main surfaces.

17. The glazing arrangement according to claim 1, wherein the refractive index is higher than that of the air and that of the first pane.

18. The glazing arrangement according to claim 3, wherein the body elements are spherical body elements.

19. The glazing arrangement according to claim 7, wherein the diameter is from 5 μm to 100 μm.

20. The glazing arrangement according to claim 19, wherein the diameter is from 50 μm to 80 μm.
